(19) United States
(12) Patent Application Publication
(10) Pub. No.: US 2026/0280703 A1
(43) Pub. Date: Sep. 17, 2026

(54) AIRPORT MANAGEMENT SYSTEM AND AIRPORT MANAGEMENT METHOD

(71) Applicant: NEC Corporation, Tokyo (JP)

(72) Inventor: Shingo HIROTA, Tokyo (JP)

(73) Assignee: NEC Corporation, Tokyo (JP)

(21) Appl. No.: 19/471,806

(22) PCT Filed: Apr. 19, 2023
(86) PCT No.: PCT/JP2023/015651

§ 371 Date: Oct. 2, 2025

(51) Int. Cl. H04B 10/11; B64F 1/36; H04B 10/29

(52) U.S. Cl. CPC H04B 10/11; B64F 1/36; H04B 10/29

(57) ABSTRACT

An airport management system that includes a detector that detects an abnormality on a taxiing area in an airport, and an optical space communicator provided in one or more aerodrome light devices in the taxiing area and relays data transmission between the detector and a management device by optical space communication.

### TECHNICAL FIELD

The present invention relates to an airport management system and an airport management method.

### BACKGROUND ART

In order to ensure safety and a flight efficiency of an airplane in an airport, runway inspection such as regular inspection of the runway (mainly for the purpose of detection of foreign matters such as fragments on a road surface) is an important work. A staff often visually performs this runway inspection. Therefore, psychological stress that overlooking is not allowed is applied to the staff, and this becomes a burden on the staff. In local airports, it is necessary to perform a large number of inspection works and maintenance works by a limited number of staffs. Therefore, there is a demand for improvement in sophistication and efficiency of the inspection work.

For example, PTL 1 describes a method for detecting a foreign substance, a fragment, or a damage in an airport using a camera or the like (PTL 1).

### CITATION LIST

### Patent Literature

PTL 1: JP 2014-513642 A

### SUMMARY OF INVENTION

### Technical Problem

Here, in an airport, it is difficult to use radio wave communication due to restrictions of the Civil Aeronautics Act and the Radio Act. In a technique in PTL 1, a camera or the like is connected to a management server with an optical fiber link. However, laying the optical fiber incurs a high cost, and a construction period is long. In a case where an optical fiber cable is laid, there is a case where it is difficult to lay the cable, and there is a possibility that the cable is cut and communication is disabled.

One aspect of the present invention has been made in view of the above problems, and an example of objects of the present invention is to achieve a technology for constructing a communication network at a low cost in an airport and efficiently inspecting a taxiing area.

### Solution to Problem

An airport management system according to one aspect of the present invention includes detection means for detecting an abnormality on a taxiing area in an airport, and optical space communication means, provided in one or more aerodrome light devices in the taxiing area, for relaying data transmission between the detection means and management means, by optical space communication.

An airport management method according to one aspect of the present invention includes detecting an abnormality on a taxiing area in an airport by detection means, and relaying data transmission between the detection means and management means, by optical space communication by optical space communication means provided in one or more aerodrome light devices in the taxiing area.

An aerodrome light device according to one aspect of the present invention is an aerodrome light device, disposed in a taxiing area in an airport, including optical space communication means for relaying data transmission between detection means for detecting an abnormality on the taxiing area in the airport and management means, by optical space communication.

### Advantageous Effects of Invention

According to one aspect of the present invention, it is possible to construct a communication network at a low cost in an airport and efficiently inspect a taxiing area.

### BRIEF DESCRIPTION OF DRAWINGS

FIG. 1 is a block diagram illustrating an example of a schematic configuration of an airport management system according to a first example embodiment of the present invention.

FIG. 2 is a flowchart illustrating an example of a flow of an airport management method according to the first example embodiment of the present invention.

FIG. 3 is a diagram illustrating an example of a schematic configuration of an airport management system according to a second example embodiment of the present invention.

FIG. 4 is a block diagram illustrating an example of a schematic configuration of an aerodrome light device according to the second example embodiment of the present invention.

FIG. 5 is a block diagram illustrating an example of a schematic configuration of an aerodrome light device according to a third example embodiment of the present invention.

FIG. 6 is a block diagram illustrating an example of a schematic configuration of a computer according to the example embodiments of the present invention.

### EXAMPLE EMBODIMENT

### First Example Embodiment

A first example embodiment of the present invention will be described in detail with reference to the drawings. The present example embodiment is a basic form of the example embodiment described below.

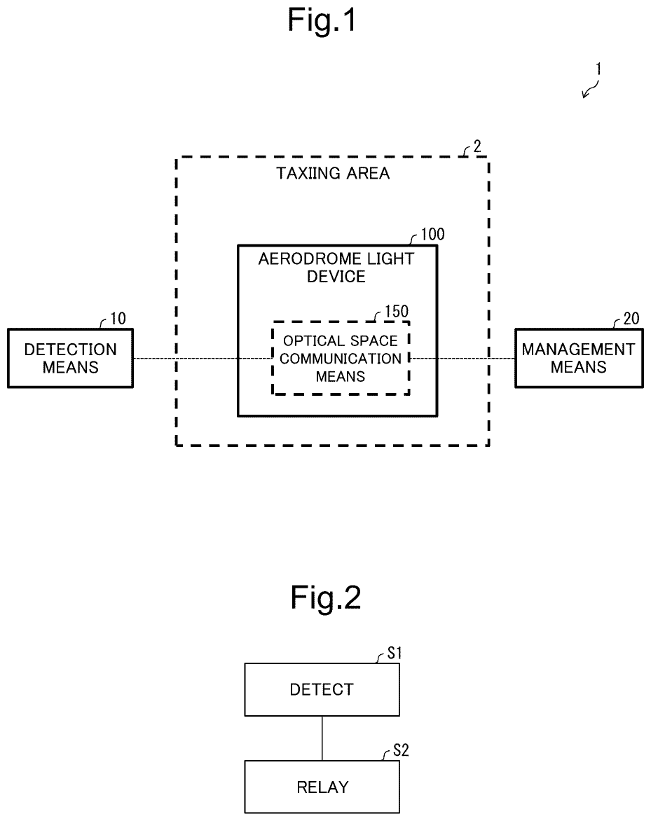

FIG. 1 is a block diagram illustrating an example of a schematic configuration of an airport management system 1 according to the present example embodiment. The airport management system 1 according to the present example embodiment includes detection means 10 for detecting an abnormality on a taxiing area 2 in an airport, and optical space communication means 150 that is provided in one or more aerodrome light devices 100 in the taxiing area 2 and relays data transmission between the detection means 10 and management means 20, by optical space communication.

Here, the taxiing area indicates a portion of the airport excluding an apron used for takeoff, landing, and taxiing of an aircraft and includes, for example, a runway, a landing area, a taxiway, or the like. The abnormality on the taxiing area includes a state where a foreign substance exists on the taxiing area and a state where a road surface of the taxiing area is damaged. For example, although the foreign substances on the taxiing area include, but are not limited to a surveying rod, a rubber glove, an asphalt piece, a crushed spring, a screw, a monkey wrench, a tire piece, a bolt nut, a piece of metal, or the like.

Here, the aerodrome light is a light used in the airport including, but not limited to, for example, an apron light, a visual docking guidance system, a runway threshold light, a wing bar light, a runway touchdown zone light, a precision approach path indicator, a runway distance marker light, a runway centerline light, a runway edge light, an approach guidance light, an approach light beacon, an overrun area light, a wind direction indicator light, an obstacle light, a taxiway centerline light, a taxiway edge light, an intermediate holding position light, a taxiway guidance sign, a stop bar light, a runway guard light, a runway entrance light, a runway threshold identification light, a takeoff hold light, an approach lighting system, a sequenced flashing light, or the like.

Here, the optical space communication is communication using light propagating in a space. The light used for the optical space communication may include millimeter waves, submillimeter waves, infrared light, visible light, ultraviolet light, or the like.

The detection means 10 is a device that detects an abnormality on the taxiing area 2 and may be, for example, a camera that images the taxiing area 2, a Light Detection and Ranging (LiDAR) that generates point cloud data of the taxiing area 2, or the like. The detection means 10 may be installed, for example, in existing equipment in the airport, for example, a fence or the like.

The management means 20 is a device that processes data indicating a detection result of the detection means 10. For example, in a case where the detection means 10 is a camera, the management means 20 may acquire captured data imaged by the camera and execute display processing for displaying the captured data on a display screen or may execute determination processing for determining whether there is an abnormality based on the captured data. In a case where the detection means 10 is a LiDAR, the management means 20 may acquire the point cloud data generated by the LiDAR, generate a stereoscopic image related to the point cloud data, and execute the display processing for displaying the image on the display screen or may execute the determination processing for determining whether there is an abnormality based on the point cloud data. For example, the management means 20 may be installed in a control room of the airport.

The aerodrome light device 100 is a device that has a function as an aerodrome light. The aerodrome light device 100 according to the present example embodiment is the aerodrome light device 100 disposed in the taxiing area 2 of the airport and includes the optical space communication means 150 that relays the data transmission between the detection means 10 that detects the abnormality on the taxiing area 2 in the airport and the management means 20, by the optical space communication.

The aerodrome light device 100 may incorporate the optical space communication means 150 or may have a configuration in which the optical space communication means 150 is added to the aerodrome light device 100. Some or all of the aerodrome lights in the taxiing area 2 may be configured as the aerodrome light device 100. The number of aerodrome light devices 100 is not particularly limited and may be one or more, but preferably plural.

The optical space communication means 150 relays the data transmission between the detection means 10 and the management means 20, by the optical space communication. In other words, the optical space communication means 150 constitutes a part of a communication path for transmitting data (for example, captured data, point cloud data, or the like) indicating the detection result of the detection means 10 to the management means 20.

FIG. 2 is a flowchart illustrating an example of an airport management method according to the present example embodiment. The airport management method according to the present example embodiment detects the abnormality on the taxiing area 2 in the airport by the detection means 10 and relays the data transmission between the detection means 10 and the management means 20, by the optical space communication by the optical space communication means 150 provided in the one or more aerodrome light devices 100 in the taxiing area 2.

In step S1, the detection means 10 detects the abnormality on the taxiing area 2 in the airport and generates the data indicating the detection result. In step S2, the optical space communication means 150 relays the data transmission between the detection means 10 and the management means 20, by the optical space communication.

### (Effects of Present Example Embodiment)

Here, as described above, in a case where an optical fiber is used for data transmission in the airport, problems such as cost and a construction period arise. In the airport, it is difficult to use radio wave communication due to restrictions of the Civil Aeronautics Act and the Radio Act. Moreover, if a wireless communication device is added to the aerodrome light, there is a case where it is difficult to perform wireless communication due to an interference caused by road surface reflection.

On the other hand, according to the present example embodiment, the one or more optical space communication means 150 provided in the aerodrome light device 100 in the taxiing area 2 relays the data transmission between the detection means 10 and the management means 20, by the optical space communication. As a result, by using the existing aerodrome light in the taxiing area 2, the problems of the cost and the construction period can be reduced, and a communicable area can be widened without being affected by terrain of the taxiing area 2. By using the optical space communication, communication can be performed with no problem, even in communication near the road surface, without restricted by the Civil Aeronautics Act and the Radio Act. As a result, it is possible to suitably achieve monitoring of the abnormality on the taxiing area using the camera, the LiDAR, or the like, without relying only on manual visual recognition.

### Second Example Embodiment

A second example embodiment of the present invention will be described in detail with reference to the drawings. Components having the same functions as the components described in the first example embodiment are denoted by the same reference signs, and the description thereof will be appropriately omitted.

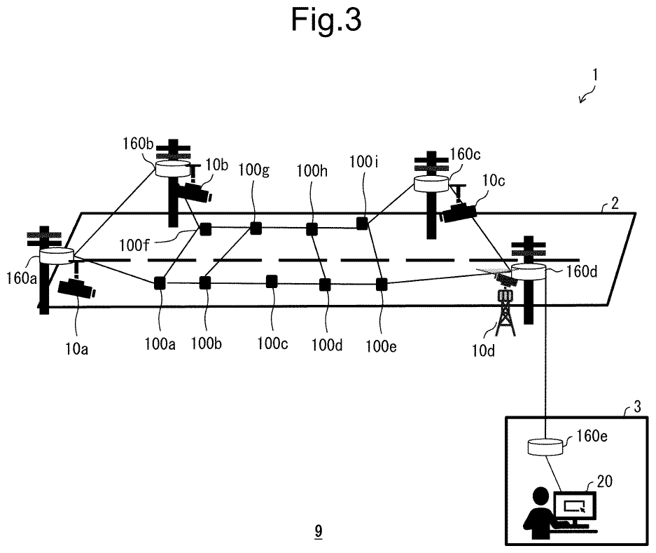

FIG. 3 is a diagram illustrating an example of a schematic configuration of an airport management system 1 according to the present example embodiment. The airport management system 1 according to the present example embodiment includes detection means 10a to 10d, aerodrome light devices 100a to 100i, second optical space communication means 160a to 160e, and management means 20.

The detection means 10a to 10d may be collectively referred to as detection means 10. Similarly, the aerodrome light devices 100a to 100i may be collectively referred to as an aerodrome light device 100. The second optical space communication means 160a to 160e may be collectively referred to as second optical space communication means 160.

The detection means 10 is provided in existing equipment such as a fence, at a position where an abnormality on a taxiing area 2 in an airport 9 can be detected. In the example illustrated in FIG. 3, the detection means 10a to 10c are cameras that image the taxiing area 2, and the detection means 10d is a LiDAR that generates point cloud data on the taxiing area 2.

Although a disposed position of the detection means 10 is not particularly limited, the detection means 10 may be dispersedly attached to a plurality of high positions in the taxiing area 2, in such a way as to detect a wide range of the taxiing area 2.

The aerodrome light device 100 is provided in the taxiing area 2. The aerodrome light device 100 may be provided, for example, on a runway, a landing area, a taxiway, or a plurality of these places, in the taxiing area 2.

In one aspect, the management means 20 is provided in a control room 3 of the airport 9. As a result, since it is possible to know the abnormality in the taxiing area 2 by the management means 20, in the control room 3 of the airport 9, for example, it is possible to promptly issue an instruction or the like to an aircraft or the like based on the abnormality. However, the management means 20 may be provided outside the control room 3 or may be provided outside the airport 9. The management means 20 may include a display device such as a display for displaying a detection result of the detection means 10.

In one aspect, in a case of recognizing the abnormality on the taxiing area 2, the management means 20 may send a control signal to the detection means 10, align a direction of the detection means 10 to a position where the abnormality exists, and observe the abnormality in detail.

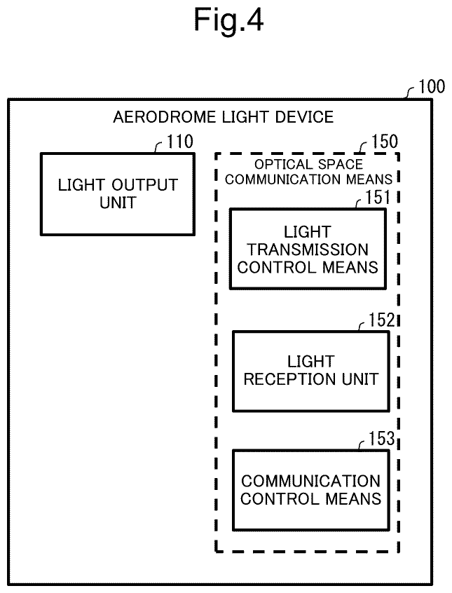

FIG. 4 is a block diagram illustrating an example of a schematic configuration of the aerodrome light device 100 according to the present example embodiment. In one aspect, the aerodrome light device 100 includes a light output unit 110 that outputs light. Although the light output unit 110 is not particularly limited, as long as the light output unit 110 can output light as an aerodrome light, for example, the light output unit 110 can include a Light Emitting Diode (LED).

In one aspect, the optical space communication means 150 includes light transmission control means 151 for controlling the light output unit 110 and transmitting light for optical space communication, a light reception unit that receives the light for the optical space communication, and communication control means (path control means) 153 for controlling the optical space communication.

In a case where the aerodrome light device 100 relays data transmission between the detection means 10 and the management means 20, the communication control means 153 controls the light transmission control means 151 and the light reception unit 152 and achieves the optical space communication. Specifically, the light transmission control means 151 controls the light output unit 110, causes the optical space communication means which is a communication partner to send the light for the optical space communication, and receives the light sent from the optical space communication means that is the communication partner by the light reception unit 152.

In one aspect, the light transmission control means 151 can superimpose a communication signal of the optical space communication on a high frequency component of an optical signal while appropriately outputting light as the aerodrome light, by blinking the light output from the light output unit 10 at a high frequency.

As a result, since the optical space communication can be performed using the light of the aerodrome light, it is possible to achieve both functions with a less device installation space.

In one aspect, the optical space communication means 150 provided in the one or more aerodrome light devices 100 may construct a mesh network by the optical space communication.

Here, the mesh network indicates a network including a plurality of nodes (the aerodrome light device 100, in the present example embodiment) and links between the nodes that is a network in which at least one node includes links with three or more nodes in such a way that it is possible to set a plurality of communication paths, as a communication path between specific nodes.

In the example illustrated in FIG. 3, a link by the optical space communication is constructed between the aerodrome light device 100a and each of the aerodrome light devices 100b and 100f. The link by the optical space communication is constructed between the aerodrome light device 100b and each of the aerodrome light devices 100a, 100c, and 100g. The link by the optical space communication is constructed between the aerodrome light device 100c and each of the aerodrome light devices 100b and 100d. The link by the optical space communication is constructed between the aerodrome light device 100d and each of the aerodrome light devices 100c, 100e, and 100h. The link by the optical space communication is constructed between the aerodrome light device 100e and each of the aerodrome light devices 100d and 100i. The link by the optical space communication is constructed between the aerodrome light device 100f and each of the aerodrome light devices 100a and 100g. The link by the optical space communication is constructed between the aerodrome light device 100g and each of the aerodrome light devices 100f, 100b, and 100h. The link by the optical space communication is constructed between the aerodrome light device 100h and each of the aerodrome light devices 100d, 100g, and 100i. The link by the optical space communication is constructed between the aerodrome light device 100i and each of the aerodrome light devices 100h and 100e. As a result, for example, as a communication path between the aerodrome light devices 100a and 100e, a plurality of communication paths including a communication path via the aerodrome light devices 100b, 100c, and 100d, a communication path via the aerodrome light devices 100f, 100g, 100h, and 100i, or the like can be set.

In a case where light other than laser light is used as the light for the optical space communication, it is preferable to avoid interference between the links, by making a wavelength, a modulation method, or both of them be different for each link.

In one aspect, the airport management system 1 according to the present example embodiment may include the path control means for controlling the communication path of the optical space communication in the mesh network, according to a situation of the optical space communication in the mesh network.

In one aspect, the communication control means 153 included in each aerodrome light device 100 may function as the path control means, or the management means 20 may function as the path control means. In a case where the communication control means 153 included in each aerodrome light device 100 functions as the path control means, the communication control means 153 switches a communication partner of the aerodrome light device 100 in such a way as to control the communication path. In a case where the management means 20 functions as the path control means, the management means 20 transmits a control signal for instructing to switch the communication path to the communication control means 153 of each aerodrome light device 100 in such a way as to control the communication path.

For example, in the example illustrated in FIG. 3, in a case where communication between the aerodrome light devices 100b and 100c is blocked by an obstacle (for example, an aircraft or the like) when communication between the aerodrome light devices 100a and 100e is performed through the communication path via the aerodrome light devices 100b, 100c, and 100d, the path control means may control communication between the aerodrome light devices 100a and 100e to be performed through the communication path via the aerodrome light devices 100f, 100g, 100h, and 100i. As a result, in a case where the communication path is blocked and communication cannot be sufficiently performed, for example, due to the aircraft passing through the taxiing area 2, during communication through a certain communication path in the mesh network, communication can be continued by switching the communication path to another communication path.

In one aspect, the detection means 10 includes the second optical space communication means 160 for performing the optical space communication with the optical space communication means 150 included in the aerodrome light device 100. In the example illustrated in FIG. 3, the detection means 10a to 10d respectively include the second optical space communication means 160a to d. As a result, data indicating the detection result of the detection means 10 can be transmitted via the optical space communication means 150 included in the aerodrome light device 100. In one aspect, the management means 20 includes the second optical space communication means 160e. As a result, the management means 20 can acquire the data indicating the detection result of the detection means 10 transmitted via the optical space communication means 150 included in the aerodrome light device 100.

The second optical space communication means 160 may use laser light as the light for the optical space communication. In this case, the optical space communication means 150 that communicates with the second optical space communication means 160 may further include light transmission/reception means for optical space communication using laser light.

### Third Example Embodiment

A third example embodiment of the present invention will be described in detail with reference to the drawings. Components having the same functions as the components described in the first or second example embodiment are denoted by the same reference signs, and the description thereof will be appropriately omitted.

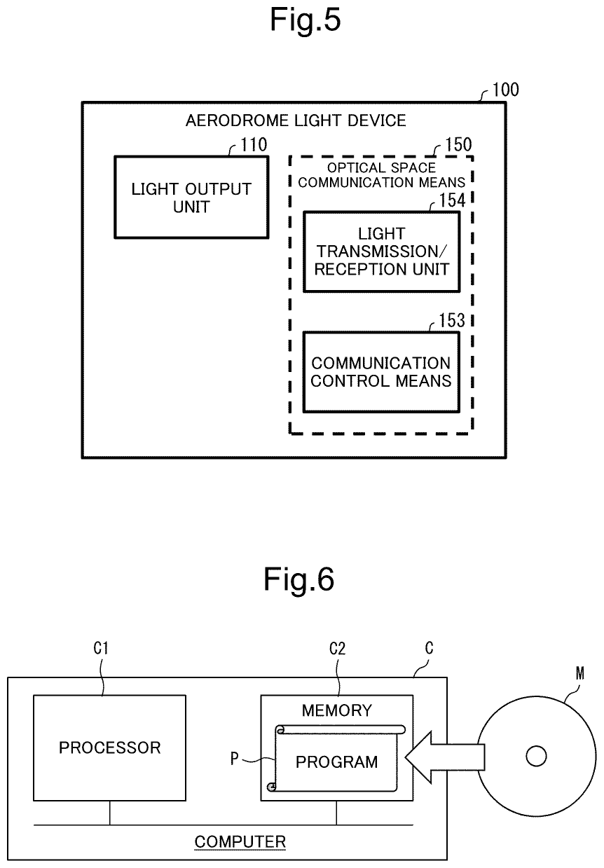

FIG. 5 is a block diagram illustrating an example of a schematic configuration of an aerodrome light device 100 according to the present example embodiment. In one aspect, the aerodrome light device 100 includes a light output unit 110 that outputs light. Optical space communication means 150 includes communication control means 153 and a light transmission/reception unit 154 for optical space communication, different from the light output unit 110.

The light transmission/reception unit 154 may transmit/receive laser light as light for the optical space communication, for example. As a result, since it is possible to perform the optical space communication using light different from light of an aerodrome light (for example, laser or the like), interference with the light of the aerodrome light can be reduced. In a case where a mesh network is constructed, it is possible to avoid interference between links.

In a case where the light transmission/reception unit 154 transmits/receives the laser light, the communication control means 153 may control optical axis alignment of the light transmission/reception unit 154. Hereinafter, an example of the optical axis alignment of the light transmission/reception unit 154 of an aerodrome light device 100a and the light transmission/reception unit 154 of an aerodrome light device 100b will be described. Hereinafter, as an example, although a flow will be described in which the light transmission/reception unit 154 of the aerodrome light device 100a performs scanning and performs optical axis alignment with the light transmission/reception unit 154 of the aerodrome light device 100b that is a communication partner, optical axis alignment between any light transmission/reception units 154 can be similarly performed. “Scan” may be referred to as “search”. The following operation is executed by controlling each light transmission/reception unit 154 by each communication control means 153.

The light transmission/reception unit 154 of the aerodrome light device 100a emits scanning light and changes a light emission direction of the scanning light (scan). Then, the scanning light emitted from the light transmission/reception unit 154 of the aerodrome light device 100a in a certain direction is received by the light transmission/reception unit 154 of the aerodrome light device 100b.

The scanning light includes identification information for specifying the aerodrome light device 100a and direction information (an azimuth angle, an elevation angle, and a depression angle) indicating a direction of light emission.

In a case where the light transmission/reception unit 154 of the aerodrome light device 100b can receive the scanning light, that is, in a case where the optical axes of the light transmission/reception units 154 match, the communication control means 153 of the aerodrome light device 100b acquires the identification information and the direction information included in the scanning light and specifies the direction of the aerodrome light device 100a. The communication control means 153 of the aerodrome light device 100b may specify a distance to the aerodrome light device 100a, based on attenuation of the scanning light. As a result, the communication control means 153 of the aerodrome light device 100b can specify a relative position of the aerodrome light device 100a.

Then, the light transmission/reception unit 154 of the aerodrome light device 100b emits response light toward the light transmission/reception unit 154 of the aerodrome light device 100a. The response light includes identification information for specifying the aerodrome light device 100b, the direction information acquired from the scanning light, and distance information to the aerodrome light device 100a specified by the communication control means 153 of the aerodrome light device 100b. When the light transmission/reception unit 154 of the aerodrome light device 100a receives the response light, the communication control means 153 of the aerodrome light device 100a acquires the identification information, the direction information, and the distance information included in the response light. Based on the acquired information, the communication control means 153 of the aerodrome light device 100a can specify a direction and a distance of the aerodrome light device 100b and specify a relative position of the aerodrome light device 100b. Thus, the optical axis alignment is completed.

Although an example of a case where an optical space communication device automatically performs optical axis alignment has been described above, the optical axis alignment may be manually performed.

In one aspect, for example, the light transmission/reception unit 154 includes a Liquid Crystal On Silicon (LCOS) device that may be achieved by ferroelectric liquid crystal, homogeneous liquid crystal, vertical alignment liquid crystal, or the like, and this makes it possible to adjust a light emission direction and the number of pieces of light to be transmitted.

### Example of Implementation by Software

Some or all of the functions of each control unit (for example, the management means 20, the light transmission control means 151, and the communication control means 153) of the airport management system 1 may be achieved by hardware such as an integrated circuit (IC) chip or may be achieved by software.

In the latter case, each control unit of the airport management system 1 is achieved, for example, by a plurality of computers for executing a command of a program which is software that achieves each function. An example of such a computer (hereinafter, referred to as a computer C) is illustrated in FIG. 6. The computer C includes at least one processor C1 and at least one memory C2. The memory C2 records a program P for causing the computer C to operate as each control unit of the airport management system 1. In the computer C, the processor C1 achieves the function of each control unit of the airport management system 1, by reading the program P from the memory C2 and executing the program P.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof can be used. As the memory C2, for example, a flash memory, a Hard Disk Drive (HDD), a Solid State Drive (SSD), a combination thereof, or the like can be used.

The computer C may further include a Random Access Memory (RAM) for loading the program P at the time of execution and temporarily storing various types of data. The computer C may further include a communication interface for transmitting and receiving data to and from other devices. The computer C may further include an input/output interface for connecting input/output devices such as a keyboard, a mouse, a display, or a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### Supplementary Matter 1

The present invention is not limited to the above-described example embodiments, and various changes can be made without departing from the spirit and the scope as defined by the claims. For example, example embodiments obtained by appropriately combining the technical means disclosed in the above-described example embodiments are also included in the technical scope of the present invention.

### Supplementary Matter 2

Some or all the above-described example embodiments may be described as follows. However, the present invention is not limited to the following aspects.

### (Supplementary Note 1)

An airport management system including detection means for detecting an abnormality on a taxiing area in an airport and optical space communication means, provided in one or more aerodrome light devices in the taxiing area, for relaying data transmission between the detection means and management means, by optical space communication.

According to the above configuration, by relaying the data transmission between the detection means and the management means, by optical space communication using an existing aerodrome light in the taxiing area 2, it is possible to construct a communication network at a low cost in the airport, and efficiently inspect the taxiing area.

### (Supplementary Note 2)

The airport management system according to supplementary note 1, in which the aerodrome light device includes a light output unit that outputs light, and the optical space communication means includes light transmission control means for controlling the light output unit and transmitting light for the optical space communication and a light reception unit that receives the light for the optical space communication.

According to the above configuration, since the optical space communication can be performed using the light of the aerodrome light, both functions can be achieved with a less device installation space.

### (Supplementary Note 3)

The airport management system according to supplementary note 1, in which the aerodrome light device includes a light output unit that outputs light, and the optical space communication means includes a light transmission/reception unit for the optical space communication, different from the light output unit.

According to the above configuration, since it is possible to perform the optical space communication using light different from the light of the aerodrome light (for example, laser or the like), interference with the light of the aerodrome light can be reduced.

### (Supplementary Note 4)

The airport management system according to any one of supplementary notes 1 to 3, in which the optical space communication means provided in the one or more aerodrome light devices constructs a mesh network by the optical space communication and includes path control means for controlling a communication path of the optical space communication in the mesh network, according to a situation of the optical space communication in the mesh network.

According to the above configuration, in a case where the communication path is blocked and communication cannot be sufficiently performed, for example, due to an aircraft passing through the taxiing area, during communication through a certain communication path in the mesh network, communication can be continued by switching the communication path to another communication path.

### (Supplementary Note 5)

The airport management system according to any one of supplementary notes 1 to 4, in which the detection means includes second optical space communication means for performing optical space communication with the optical space communication means.

According to the above configuration, data indicating a detection result of the detection means can be transmitted via the optical space communication means.

### (Supplementary Note 6)

The airport management system according to any one of supplementary notes 1 to 5, in which the management means is provided in a control room of the airport.

According to the above configuration, since it is possible to know an abnormality in the taxiing area by the management means, in the control room of the airport, for example, it is possible to promptly issue an instruction or the like to an aircraft or the like based on the abnormality.

### (Supplementary Note 7)

An airport management method including detecting an abnormality on a taxiing area in an airport by detection means and relaying data transmission between the detection means and management means, by optical space communication by optical space communication means provided in one or more aerodrome light devices in the taxiing area. According to the above method, an effect same as that of Supplementary Note 1 is obtained.

### (Supplementary Note 8)

The airport management method according to supplementary note 7, in which the aerodrome light device includes a light output unit that outputs light, and the relaying the data transmission includes transmitting light for the optical space communication by controlling the light output unit by the optical space communication means and receiving the light for the optical space communication by the optical space communication means. According to the above method, an effect same as that of Supplementary Note 2 is obtained.

### (Supplementary Note 9)

The airport management method according to supplementary note 7, in which the aerodrome light device includes a light output unit that outputs light, and the relaying the data transmission includes transmitting/receiving light for the optical space communication, using a light transmission/reception unit for the optical space communication, different from the light output unit, by the optical space communication means. According to the above method, an effect same as that of Supplementary Note 3 is obtained.

### (Supplementary Note 10)

The airport management method according to any one of supplementary notes 7 to 9, in which the optical space communication means provided in the one or more aerodrome light devices constructs a mesh network by the optical space communication and controls a communication path of the optical space communication in the mesh network, according to a situation of the optical space communication in the mesh network. According to the above method, an effect same as that of Supplementary Note 4 is obtained.

### (Supplementary Note 11)

The airport management method according to any one of supplementary notes 7 to 10, in which the detection means and the optical space communication means perform optical space communication. According to the above method, an effect same as that of Supplementary Note 5 is obtained.

### (Supplementary Note 12)

The airport management method according to any one of supplementary notes 7 to 11, in which the management means is provided in a control room of the airport. According to the above method, an effect same as that of Supplementary Note 6 is obtained.

### (Supplementary Note 13)

An aerodrome light device disposed in a taxiing area in an airport, including optical space communication means for relaying data transmission between detection means for detecting an abnormality on the taxiing area in the airport and management means, by optical space communication. According to the above configuration, an effect same as that of Supplementary Note 1 is obtained.

### Supplementary Matter 3

Some or all the above-described example embodiments may be further described as follows.

### (Supplementary Note 1)

An airport management system including:
a detection unit for detecting an abnormality on a taxiing area in an airport; and
an optical space communication unit, provided in one or more aerodrome light devices in the taxiing area, for relaying data transmission between the detection unit and a management unit, by optical space communication.

### (Supplementary Note 2)

The airport management system according to supplementary note 1, in which
the aerodrome light device includes a light output unit that outputs light, and
the optical space communication unit includes
a light transmission control unit for controlling the light output unit and transmitting light for the optical space communication and
a light reception unit that receives the light for the optical space communication.

### (Supplementary Note 3)

The airport management system according to supplementary note 1, in which
the aerodrome light device includes a light output unit that outputs light, and
the optical space communication unit includes a light transmission/reception unit for the optical space communication, different from the light output unit.

### (Supplementary Note 4)

The airport management system according to supplementary note 1, in which
the optical space communication unit provided in the one or more aerodrome light devices constructs a mesh network by the optical space communication and
includes a path control unit for controlling a communication path of the optical space communication in the mesh network, according to a situation of the optical space communication in the mesh network.

### (Supplementary Note 5)

The airport management system according to supplementary note 1, in which the detection unit includes a second optical space communication unit for performing optical space communication with the optical space communication unit.

### (Supplementary Note 6)

The airport management system according to supplementary note 1, in which the management unit is provided in a control room of the airport.

### (Supplementary Note 7)

An airport management method including:
detecting an abnormality on a taxiing area in an airport by a detection unit; and
relaying data transmission between the detection unit and a management unit, by optical space communication by an optical space communication unit provided in one or more aerodrome light devices in the taxiing area.

### (Supplementary Note 8)

The airport management method according to supplementary note 7, in which
the aerodrome light device includes a light output unit that outputs light, and
the relaying the data transmission includes
transmitting light for the optical space communication by controlling the light output unit by the optical space communication unit and
receiving the light for the optical space communication by the optical space communication unit.

### (Supplementary Note 9)

The airport management method according to supplementary note 7, in which
the aerodrome light device includes a light output unit that outputs light, and
the relaying the data transmission includes transmitting/receiving light for the optical space communication, using a light transmission/reception unit for the optical space communication, different from the light output unit, by the optical space communication unit.

### (Supplementary Note 10)

The airport management method according to supplementary note 7, in which
the optical space communication unit provided in the one or more aerodrome light devices constructs a mesh network by the optical space communication and
controls a communication path of the optical space communication in the mesh network, according to a situation of the optical space communication in the mesh network.

### (Supplementary Note 11)

The airport management method according to supplementary note 7, in which the detection unit and the optical space communication unit perform optical space communication.

### (Supplementary Note 12)

The airport management method according to supplementary note 7, in which the management unit is provided in a control room of the airport.

### (Supplementary Note 13)

An aerodrome light device disposed in a taxiing area in an airport, including:
an optical space communication unit for relaying data transmission between a detection unit that detects an abnormality on the taxiing area in the airport and a management unit, by optical space communication.

### REFERENCE SIGNS LIST

1 airport management system
2 taxiing area in airport
3 control room
9 airport
10, 10a to 10d detection means
20 management means
100, 100a to 100i aerodrome light device
110 light output unit
150, 150-1, 150-2, 150-3, 150-4 optical space communication means
151 light transmission control means
152 light reception unit
153 communication control means (path control means)
154 light transmission/reception unit
160a to 160e second optical space communication means
C computer
C1 processor
C2 memory
P program
M data recording medium

What is claimed is:

1. An airport management system comprising:
a detector that detects an abnormality on a taxiing area in an airport; and
an optical space communicator provided in one or more aerodrome light devices in the taxiing area and relays data transmission between the detector and a management device by optical space communication.

2. The airport management system according to claim 1, wherein
the aerodrome light device includes a light output part that outputs light, and
the optical space communicator includes
a light transmission controller that controls the light output part and transmitting light for the optical space communication and
a light receptor that receives the light for the optical space communication.

3. The airport management system according to claim 1, wherein
the aerodrome light device includes a light output part that outputs light, and
the optical space communicator includes a light transmission/reception apparatus for the optical space communication, different from the light output part.

4. The airport management system according to claim 1, wherein
the optical space communicator provided in the one or more aerodrome light devices
constructs a mesh network by the optical space communication and
includes a path controller configured to control a communication path of the optical space communication in the mesh network, according to a situation of the optical space communication in the mesh network.

5. The airport management system according to claim 1, wherein
the detector includes second an optical space communicator that performs optical space communication with the optical space communicator.

6. The airport management system according to claim 1, wherein
the management device is provided in a control room of the airport.

7. An airport management method comprising:
detecting an abnormality on a taxiing area in an airport by detector; and
relaying data transmission between the detector and a management device, by optical space communication by an optical space communication provided in one or more aerodrome light devices in the taxiing area.

8. The airport management method according to claim 7, wherein
the aerodrome light device includes a light output part that outputs light, and
the relaying the data transmission includes
transmitting light for the optical space communication by controlling the light output part by the optical space communicator and
receiving the light for the optical space communication by the optical space communicator.

9. The airport management method according to claim 7, wherein
the aerodrome light device includes a light output part that outputs light, and
the relaying the data transmission includes transmitting/receiving light for the optical space communication, using a light transmission/reception apparatus for the optical space communication, different from the light output part, by the optical space communicator.

10. The airport management method according to claim 7, wherein
the optical space communicator provided in the one or more aerodrome light devices constructs a mesh network by the optical space communication and
controlling a communication path of the optical space communication in the mesh network, according to a situation of the optical space communication in the mesh network.

11. The airport management method according to claim 7, wherein
the detector and the optical space communicator perform optical space communication.

12. The airport management method according to claim 7, wherein
the management device is provided in a control room of the airport.

13. An aerodrome light device disposed in a taxiing area in an airport, comprising:
an optical space communicator that relays data transmission between a detector that detects an abnormality on the taxiing area in the airport and a management device, by optical space communication.
